(19) United States
(12) Patent Application Publication
(10) Pub. No.: US 2006/0244460 A1
(43) Pub. Date: Nov. 2, 2006

(54) System and method for battery management

(76) Inventor: Jeffrey S. Weaver, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/118,576

(22) Filed: Apr. 29, 2005

(51) Int. Cl. G01N 27/416

(52) U.S. Cl. 324/430

(57) ABSTRACT

A battery management system for managing current supplied by a battery to a load. The battery management system detects an input current and drives the load at a substantially constant voltage if the detected input current reaches a predetermined current threshold. In addition, the circuit limits the input current to the predetermined current threshold, thereby allowing the output voltage to decrease when the input current is being limited to the threshold by the circuit.

### RELATED ART

Battery-powered systems are often operationally constrained by battery characteristics. In this regard, the total battery capacity that may be available to a system is directly related to the rate of discharge of electrons from the battery, i.e., the current that is drawn from the battery by a corresponding load. Furthermore, when the battery exhibits a lower discharge rate, the battery retains more useable capacity. This is especially true when the battery is nearly discharged.

A direct current-direct current (DC-DC) converter refers to a device that is employed to change an input voltage, such as a voltage provided from a battery, to a different output voltage. Such DC-DC converters may be used to step-up, step-down, or invert an output voltage with respect to the input voltage. DC-DC converters are often used to manage the voltage supplied to a load in battery-powered systems. The DC-DC converter typically provides set output voltages to various system loads, and delivers a set output voltage from a varying input voltage.

While many loads, e.g., electronic components, require a tightly regulated input voltage to function properly, other loads, e.g., motors, are exceptions.

Depending on its load characteristics, a motor may function acceptably when supplied a voltage of 75% of the nominal value, even though a typical specification voltage tolerance for a motor may be ±10%. Therefore, in many cases the input voltage for a motor may be allowed to decrease during operation without adversely affecting the system's performance, i.e., the motor will continue to function properly.

Oftentimes, a DC-DC converter interfaces a power source, e.g., a battery, with a load, e.g., a motor. In this regard, a typical DC-DC converter supplies a constant output voltage to the load as long as the load current is less than a predetermined value. However, if the load attempts to draw more current than the limit value, standard design practices provide protection to the circuit;

the DC-DC converter either shuts down the converter or allows the output voltage to droop by maintaining the load current at a predetermined value.

### SUMMARY OF THE DISCLOSURE

Generally, the present disclosure provides a system and method for battery management.

A battery management system for managing current supplied by a battery to a load in accordance with an embodiment of the present disclosure comprises a circuit that detects an input current and drives the load at a substantially constant voltage if the detected input current reaches a predetermined current threshold. In addition, the circuit limits the input current to the predetermined current threshold, thereby allowing the output voltage to decrease when the input current is being limited to the threshold by the circuit.

A battery management method for managing current supplied by a battery to a load in accordance with an embodiment of the present disclosure comprises the steps of detecting a current and driving, based on the current, the load with a constant voltage if the current is below a predetermined current threshold. In addition, the method comprises the step of reducing the voltage when the input current reaches the predetermined current threshold such that the current is limited to the predetermined current threshold.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram depicting a device employing a battery management system in accordance with an exemplary embodiment of the present disclosure.

FIG. 2 is a block diagram depicting the battery management system of FIG. 1.

FIG. 3 is a block diagram depicting an exemplary circuit-level implementation of the battery management system of FIG. 2.

FIG. 4 is a graph illustrating exemplary behavior of the circuit depicted in FIG. 3 when the input current is below a predetermined threshold.

FIG. 5 is a graph illustrating exemplary behavior of the circuit depicted in FIG. 3 when the input current is above a predetermined threshold.

FIG. 6 is a flowchart depicting exemplary architecture and functionality of the battery management system of FIG. 3.

### DETAILED DESCRIPTION

Embodiments of the present disclosure generally pertain to systems and methods for battery management. In particular, a system in accordance with one embodiment of the present disclosure comprises a battery and a DC-DC converter that provides a constant output voltage to a load. However, if the load to which the constant voltage is being provided attempts to draw an input current to the DC-DC converter from the battery that exceeds a predetermined current threshold value, the battery management system allows the output voltage driving the load to decrease as needed to limit the input current to the predetermined current threshold value.

In this regard, if the input current to the DC-DC converter remains below a predetermined current threshold value, the battery management system provides a substantially constant output voltage to the load. However, if the input current attempts to exceed the predetermined current threshold value, i.e., the load is attempting to draw a current from the battery that exceeds the predetermined current threshold value, the battery management system of the present disclosure limits the amount of input current that is drawn from the battery and allows the output voltage provided to the load to decrease. As described hereinabove, for particular loads that have liberal input voltage tolerances, e.g., motors, such decrease is acceptable.

Thus, decreasing the output voltage to the load when the battery is significantly discharged, decreases the input current to the DC-DC converter.

Such allowable decrease in the output voltage, therefore, tends to increase the life of the battery that is supplying voltage to the DC-DC converter. This is especially so when the battery is significantly discharged.

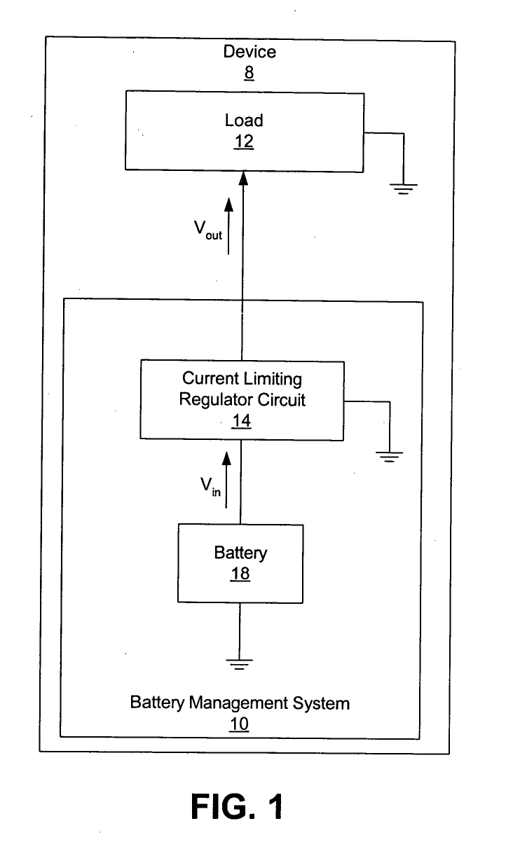

FIG. 1 depicts a device 8, e.g., a digital camera, comprising a battery management system 10 in accordance with an embodiment of the present disclosure. The battery management system 10 provides power to a load 12. The load 12 preferably comprises a motor. For example, the load may comprise a motor that drives an optical zoom lens. Notably, the battery management system of the present disclosure may be employed for other types of loads in other embodiments.

The battery management system 10 comprises a battery 18 and a current limiting regulator circuit 14. The regulator circuit 14 connects the battery 18 to the load 12. The battery 18 applies a voltage Vᵢₙ to the regulator circuit 14, and the regulator circuit 14 provides voltage Vₒᵤₜ to the load 12. The regulator circuit 14 ensures that the output voltage Vₒᵤₜ is substantially constant during operation, except as otherwise indicated herein.

Furthermore, the regulator circuit 14 senses a current induced in the circuit 14 by the input voltage Vᵢₙ. If the input current sensed by the regulator circuit 14 is above a predetermined current threshold value based on the battery characteristics and the specifications of the load 12, then the regulator circuit 14 limits the current that is drawn at the input of the regulator circuit 14. Determination of a predetermined current threshold value is described further herein.

Thus, despite the current that is demanded by the load 12, the current that is actually drawn from the battery 18 is limited by the regulator circuit 14. As a result, the voltage Vₒᵤₜ that is provided to the load 12 by the regulator circuit 14 when the current is limited may decrease. However, as described herein, there are some loads, such as motors, for example, that have liberal input voltage tolerances. For such loads, a decrease in input voltage in order to increase battery life is acceptable.

As described herein, the regulator circuit 14 operates based upon a predetermined current threshold value. In this regard, if the input current is below the predetermined current threshold value, then the regulator circuit 14 behaves as a constant voltage source. If the input current attempts to exceed the predetermined current threshold value, then the regulator circuit 14 lowers the output voltage so that the input current is limited to the predetermined current threshold value. Therefore, in one embodiment, the circuit 14 is preferably designed around a predetermined current threshold value that is determined based upon the system amperage requirements and the particular load 12 amperage requirements.

For example, the device may be a digital camera that maintains a peak discharge rate at or below 1.5 amps for a particular battery 18, e.g., a lithium ion cell battery. Thus, if the camera requires 0.5 amps without considering the load 12, then the current that the regulator circuit 14 might allow to the load 12, i.e., the predetermined current threshold value, is 1.0 amps, i.e., the total peak discharge rate minus the total amperage required to run the camera.

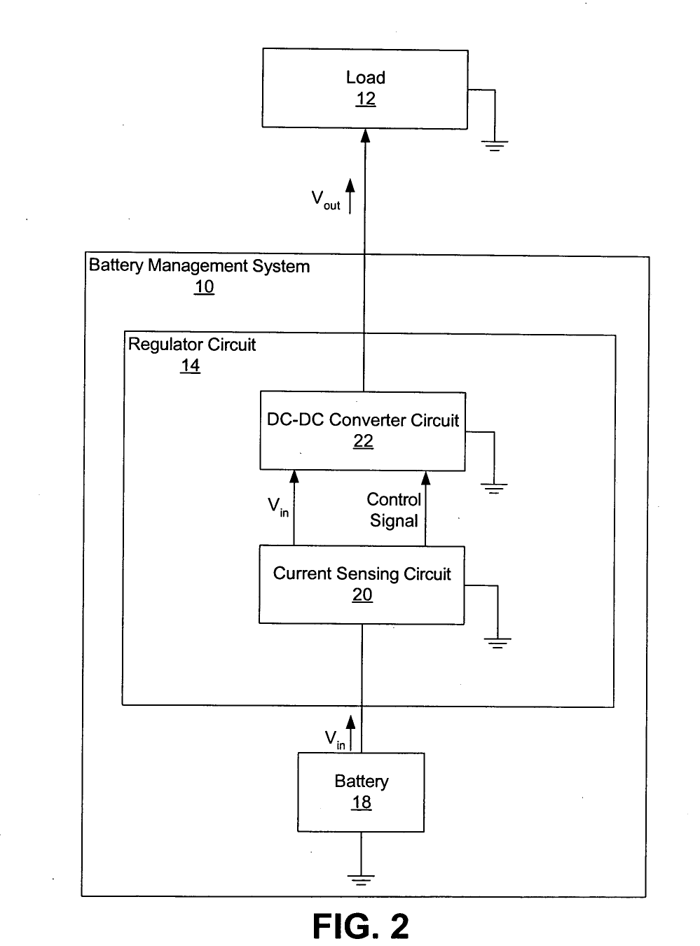

FIG. 2 depicts a more detailed regulator circuit 14 in accordance with an embodiment of the present disclosure. The regulator circuit 14 comprises a direct current-direct current (DC-DC) converter circuit 22 and a current sensing circuit 20.

The DC-DC converter circuit 22 accepts the input voltage Vᵢₙ from the battery 18. The DC-DC converter circuit 22 translates the input voltage Vᵢₙ into a DC output voltage Vₒᵤₜ. The DC-DC converter circuit 22 may provide a higher output voltage Vₒᵤₜ than the input voltage Vᵢₙ, provide a lower output voltage Vₒᵤₜ than the input voltage Vᵢₙ, or provide an inverted output voltage Vₒᵤₜ with respect to the input voltage Vᵢₙ. In this regard, the circuit 22 may be a “boost converter,” a “buck converter,” or an “inverting converter,” respectively.

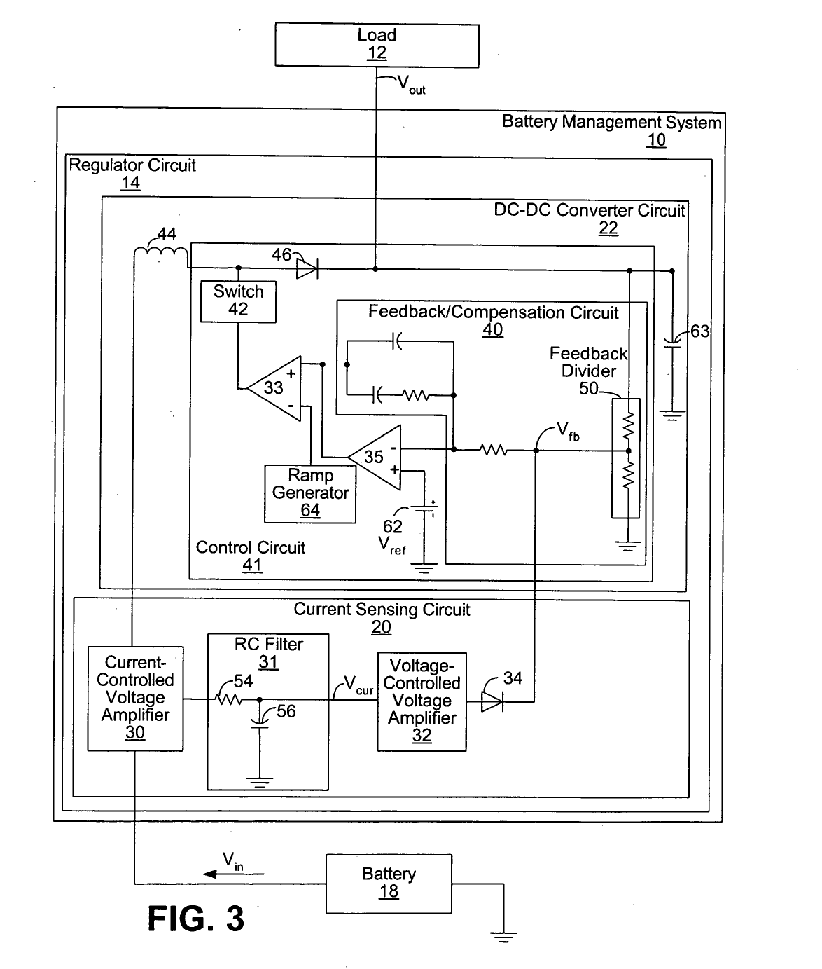

The DC-DC converter circuit 22 may use an energy-storage element, such as an inductor, a transformer, or a capacitor, to transfer energy from the battery 18 to the load 12 in discrete packets. Feedback circuitry employed within the circuit 22 may regulate the energy transfer to maintain a constant output voltage Vₒᵤₜ that falls within the load limits of the load 12. A more detailed exemplary DC-DC circuit configuration having feedback circuitry is described in more detail with reference to FIG. 3.

The current sensing circuit 20 of FIG. 2 detects a current induced in the regulator circuit 14 by the input voltage Vᵢₙ applied by the battery 18. If the current detected falls below a predetermined current threshold value, as described hereinabove, the DC-DC converter circuit 22 continues to regulate the output voltage using a voltage value internal to the DC-DC converter circuit 22. However, if the input current detected by the current sensing circuit 20 is above the predetermined current threshold value, then the current sensing circuit 20 drives the DC-DC converter circuit 22 with a voltage translated from the detected input current.

FIG. 3 depicts in more detail the DC-DC converter circuit 22 and the current sensing circuit 20 described in FIG. 2.

As shown by FIG. 3, the DC-DC converter circuit 22, whose method of operation is well-known in the art, comprises generally an inductor 44, a control circuit 41, and a capacitor 63. The control circuit 41, which regulates the output voltage Vₒᵤₜ, comprises a switch 42, a comparator 33, an operational amplifier 35, and a feedback circuit 40 corresponding to the operational amplifier 35.

During operation, the switch 42 is opened and closed periodically. In this exemplary embodiment of the DC-DC converter circuit 22, the frequency, i.e., number of times per second, that the switch 42 is actuated is constant, and the on-time of switch 42 is modulated. The capacitor 63 exhibits a substantially constant voltage value with a small-amplitude ripple voltage caused by the switching action. When switch 42 is closed, the input voltage Vᵢₙ is impressed across the inductor 44, and the diode 46 prevents the capacitor 63 from discharging to ground. Therefore, current ramps up in the inductor 44. During the period when the switch 42 is closed, the capacitor 63 supplies the load current, so the voltage across capacitor 63 drops slightly.

When the switch 42 opens again, the voltage across the inductor 44 changes such that the diode 46 is biased forward so that inductor 44 continues providing current flow and supply the load current, recharging capacitor 63 and slightly raising the voltage across capacitor 63. Additionally, the feedback circuit 40, comparator 33, ramp generator 64, and the operational amplifier 35 work in conjunction to control the output voltage Vₒᵤₜ by modulating the time switch 42 is on during the switching period, thereby keeping the output voltage Vₒᵤₜ at a substantially constant voltage. In this regard, the output voltage Vₒᵤₜ is regulated.

The operational amplifier 35 comprises a non-inverting input (+) and an inverting input (−). During operation, the operational amplifier 35 operates to ensure that the voltages at both inputs, the inverting and the non-inverting, remain substantially at the same voltage. For example, if V_{ref} produced by voltage source 62 is 1.65 Volts, then the amplifier 35 operates to ensure that the voltage at the non-inverting input (−) is 1.65 Volts, and in such an example, the feedback voltage V_{fb} generated by feedback divider 50 remains at 1.65 volts. Ramp generator 64 supplies a saw-tooth waveform to comparator 33, which then converts the error voltage generated by operational amplifier 35 into a duty cycle suitable for controlling switch 42. In this regard, the control circuit 41 regulates the output voltage Vₒᵤₜ based upon the feedback voltage V_{fb}.

Notably, the DC-DC converter circuit 22 is an exemplary implementation known in the art. Other circuitry implementations of the DC-DC converter circuit 22 now known or future-developed are possible in other embodiments. Furthermore, as described herein, the DC-DC converter circuit 22 may be implemented in such a manner as to increase the output voltage Vₒᵤₜ, decrease the output voltage Vₒᵤₜ, or invert the output voltage Vₒᵤₜ with respect to the input voltage Vᵢₙ. The exemplary DC-DC converter circuit 22 increases the input voltage Vᵢₙ and regulates the output voltage Vₒᵤₜ to a substantially constant output voltage Vₒᵤₜ.

The current sensing circuit 20 is electrically connected to the input voltage Vᵢₙ and the DC-DC converter circuit 22. Generally, the current sensing circuit 20 detects the input current of the regulator circuit 14 from the battery 18. If the input current remains below a predetermined current threshold value, then the DC-DC converter circuit 22 boosts the input voltage Vin, converts the input voltage Vᵢₙ into a substantially constant output voltage Vₒᵤₜ, and provides such substantially constant output voltage Vₒᵤₜ to the load 12, as described hereinabove. As noted herein, the load 12 may be a motor, for example. In this regard, the control circuit 41 regulates the output voltage Vₒᵤₜ based upon the feedback voltage V_{fb} generated by feedback divider 50.

However, if the current exceeds the predetermined current threshold value, then the current sensing circuit 20 provides a control signal to the control circuit 41, and the control circuit 41 regulates the output voltage Vₒᵤₜ based upon the control signal provided by the current sensing circuit 20 as opposed to the regulator circuit's internal feedback voltage V_{fb}.

In this regard, the current sensing circuit 20 comprises a current-controlled voltage amplifier 30, a resistance/capacitance filter (R/C filter) 31, a voltage-controlled voltage amplifier 32, and a diode 34. Generally, each of these components works in conjunction to detect the input current and limit the input current to a predetermined current threshold value.

During operation, Vᵢₙ is impressed across the current-controlled voltage amplifier 30. The current-controlled voltage amplifier 30 measures the current induced in the circuit 20 by regulator circuit 14, provided by battery 18, and translates the measured current into a voltage having a gain specified by a particular circuit element. For example, if the current-controlled voltage amplifier 30 had a constant gain of 1, and the current through the wire is 1 amp, then there will be 1 volt at the output of the amplifier 30.

The current-controlled voltage amplifier 30 can be effectuated in numerous ways known to those skilled in the art. Such a current-controlled voltage amplifier can comprise a plurality of electronic components that work in conjunction to detect the input current, translate the current to a voltage and apply a gain to the voltage. For example, the current-controlled amplifier 30 might comprise a “sense resistor,” which refers to an electronic component comprising a resistor placed in a current path to allow the current to be measured. The voltage across the sense resistor is proportional to the current that is being measured and an amplifier produces a voltage or current that drives the measurement. Additionally, a difference amplifier might be used to measure the current induced in the circuit 20 by the Vᵢₙ provided by the battery 18. In this regard, the amplifier 30 generally senses the current through the amplifier 30 and translates the current into a voltage which has a gain value dependent upon a gain constant implemented in the amplifier 30.

The inductor 44 receives the voltage output of the current controlled voltage amplifier 30, and the current through the inductor appears as a DC component representing the average input current required to supply the load summed with a triangular wave due to the switching action of switch 42.

The current sensing circuit 20 of FIG. 3 comprises an R/C filter 31. The R/C filter 31 receives the DC plus triangular wave output from the amplifier 30 and averages the waveform, effectively removing the triangular wave from the signal to provide a D/C representation of the current. The R/C filter 31 in the circuit 20 comprises a resistor 54 and a capacitor 56. Therefore, the filter 31 removes the switching ripple from the waveform provided by the battery 18.

The voltage-controlled voltage amplifier 32 receives the averaged current from the R/C filter 31. The voltage-controlled voltage amplifier 32 scales the current so that the voltage output at an input current equal to the predetermined current threshold value is equal to the reference voltage V_{ref} of the voltage source 62 plus one forward-biased diode voltage drop accommodating the drop across diode 34. The averaged current output from the R/C filter 31 is provided to the voltage-controlled voltage amplifier 32, and the voltage-controlled voltage amplifier 32 takes the gain as a function of the current and translates and/or scales the current so that at the desired current limit, e.g., 0.5 amps, the voltage output at the cathode of diode 34 is equal to V_{ref}.

In this regard, because of diode 34, if the input current is higher than the predetermined current threshold value, the current sensing circuit 20 will provide a voltage at V_{fb} higher than V_{ref}. Such voltage V_{fb} provided by the current sensing circuit 20 overrides the voltage feedback from Vₒᵤₜ Thus, the current sensing circuit 20 regulates the circuit 14 by lowering the output voltage Vₒᵤₜ to maintain V_{fb} substantially equal to V_{ref}. In this regard, the current sensing circuit 20 effectively lowers the output voltage Vₒᵤₜ and limits the input current as desired. The current sensing circuit 20 holds feedback voltage V_{fb} at the reference voltage V_{ref} either by choosing the output voltage of the voltage-controlled voltage amplifier 32, which is scaled such that the V_{fb} voltage at an input current equal to the predetermined current threshold value is held at V_{ref}, or the voltage feedback from the feedback divider 50, whichever is higher. If the input current attempts to increase above a predetermined current threshold value of 0.5 amps, e.g., the diode 34 appears as a closed circuit. In this regard, the diode 34 closes the loop and causes the loop to regulate to the current instead of the circuit 14 being regulated by the feedback voltage V_{fb} supplied by feedback divider 50.

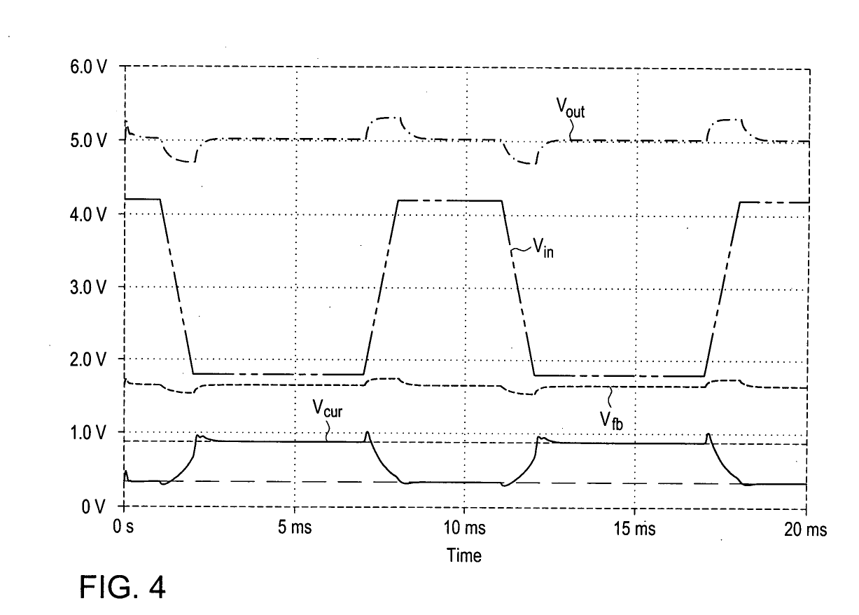

FIG. 4 is a graph illustrating the behavior of the regulator circuit 14 when the current input is not being limited by the current sensing circuit 20. The graph comprises four voltage plots corresponding to the circuit depicted in FIG. 3. The voltage plots include the output voltage Vₒᵤₜ, the input voltage Vin, the feedback voltage V_{fb}, and the current voltage V_{cur}, each of which is indicated in FIG. 3.

As noted herein, Vₒᵤₜ is the output voltage of the regulator circuit 14 and Vᵢₙ is the input voltage produced by the battery 18. V_{fb} is the feedback voltage of the control circuit 41 as indicated in FIG. 3, and V_{cur} is the current voltage as indicated on the circuit 22 in FIG. 3.

The battery 18 cycles between 4.2 volts and 1.8 volts, as indicated by the plot Vin. As the battery cycles, the input voltage Vᵢₙ drops, and the circuit 14 compensates for the cycling and tends to maintain the output voltage Vₒᵤₜ at or around 5 Volts, as indicated by the plot Vₒᵤₜ. There is a slight drop in the output voltage Vₒᵤₜ during the transition as indicated. Note that the temporary slight drop in Vₒᵤₜ during the Vᵢₙ transition is due to the output response of the DC-DC converter circuit 22 for a line transient, i.e., Vᵢₙ is changing dynamically. Further note that other voltage ranges are possible in other examples.

To better illustrate the foregoing, assume a 0.5 amp predetermined current threshold value. Further, assume the load 12 draws a current of 250 miliamps and Vₒᵤₜ is 5.0V, for example. 250 miliamps at the output translates to an input current of approximately 350 miliamps, which is less than the 0.5 amp predetermined current threshold value. As Vᵢₙ drops from 4.2 Volts to 1.8 Volts, the load 12 attempts to draw a greater input current from the battery 18, which is consistent with a dc-dc converter characteristic generally due to the need to supply a constant output power demanded by the load regardless of input voltage. In this regard, as the input voltage Vᵢₙ drops, and the current voltage V_{cur} increases, i.e., the load 12 attempts to draw greater current from the battery 18.

Thus, at 1.8 Volts, the exemplary 250 miliamp load 12 needs approximately 881 miliamp input current, which translates to the approximate 0.8 Volts of the voltage V_{cur} representing the input current when the input voltage Vᵢₙ is at 1.8 Volts. Therefore, in order to retain the output voltage Vₒᵤₜ at 5 Volts at 250 miliamps, the input current drawn from the battery 18 to retain these output characteristics is approximately 881 miliamps. The output voltage Vₒᵤₜ, as indicated, is regulated at substantially 5 Volts. Whether the input voltage is 4.2 Volts or 1.8 Volts, the regulator circuit 14 draws the needed current represented by voltage V_{cur} from the battery 18, i.e., 350 miliamps at 4.2 Volts or 881 miliamps at 1.8 Volts, to whatever value is needed to ensure that the output voltage Vₒᵤₜ is regulated at substantially 5 Volts.

FIG. 4 further illustrates the feedback voltage V_{fb} during operation of the regulator circuit 14. As described hereinabove with reference to FIG. 3, the operational amplifier 35 tends to maintain its inverting input (+) and its non-inverting input (−) at the same voltage. Therefore, as an example, if the voltage applied at the inverting input (+) is 1.65 Volts, then the operational amplifier 35 tends to maintain the feedback voltage V_{fb} at the same 1.65 Volts, which is the voltage illustrated in the example provided by FIG. 4.

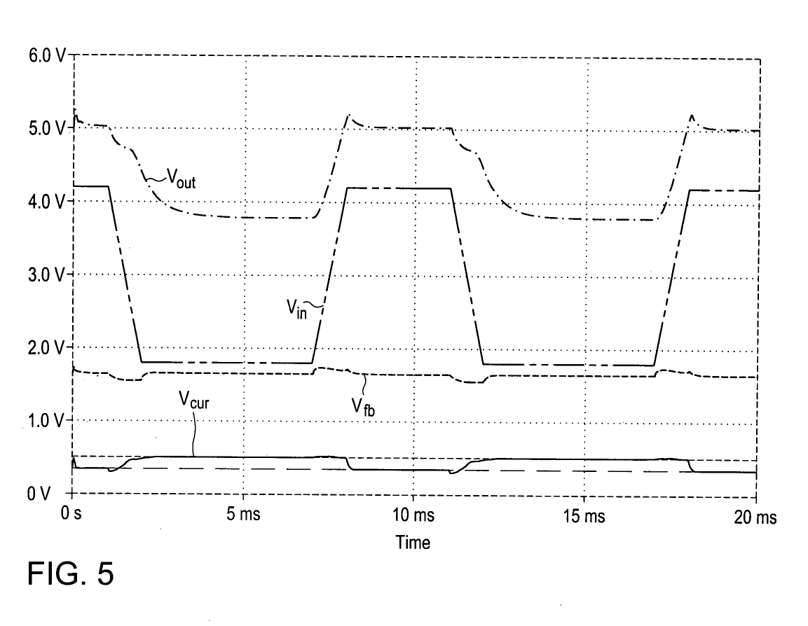

FIG. 5 is a graph illustrating the behavior of the regulator circuit 14 when the current sensing circuit 20 is implemented to limit the input current being drawn from the battery 18 by the regulator circuit 14. Like the graph depicted in FIG. 4, the graph in FIG. 5 comprises four voltage plots corresponding to the circuit depicted in FIG. 3. The voltage plots include the output voltage Vₒᵤₜ of the regulator circuit 14, the input voltage Vᵢₙ from the battery 18, the feedback voltage V_{fb} of the control circuit 41, and the current voltage V_{cur}, each of which is indicated in FIG. 3.

The battery 18 cycles between 4.2 volts and 1.8 volts, as indicated by the plot Vᵢₙ. As the battery cycles, the input voltage Vᵢₙ drops, however, unlike the regulator circuit 14 not employing current limiting, the output voltage Vₒᵤₜ tends to migrate downward and remain at a level substantially below the constant output voltage Vₒᵤₜ maintained when current limiting is not employed, as illustrated in FIG. 4. Furthermore, the current sensing circuit 20 limits the input current represented by V_{cur} to approximately 500 miliamps when the input voltage Vᵢₙ drops to the 1.8 Volts. As noted above, when the current sensing circuit 20 limits the input current represented by voltage V_{cur} to 500 miliamps and the voltage is at 1.8 volts, the output current Vₒᵤₜ drops substantially below the 5 Volts constant voltage maintained without current limiting. However, a described hereinabove, such decrease in output voltage to a load 12 is tolerable when the input voltage requirements for the load 12 is in reference to, for example, a load comprising a motor.

To better illustrate the foregoing, assume a 0.5 amp predetermined current threshold value. Further, assume the load 12 draws a current of 250 miliamps, for example. 250 miliamps translates to an input current of approximately 350 miliamps, which is less than the 0.5 amp predetermined current threshold value. As Vᵢₙ drops from 4.2 Volts to 1.8 Volts, the load 12 attempts to draw a greater input current from the battery 18, which is consistent with a dc-dc converter characteristic generally as described hereinabove. In this regard, the input voltage Vᵢₙ drops, and the current voltage V_{cur} increases, i.e., the load attempts to draw greater current from the battery 18.

However, instead of allowing the load 12 to draw 881 miliamps in order to adjust for the decrease in input voltage Vᵢₙ, the current limiting circuit limits the current drawn when the input voltage decreases to 1.8 Volts to the 0.5 amp predetermined current threshold value. Thus, when the current sensing circuit 20 is operating, at an input voltage of 1.8 Volts, the load 12 receives less than 5 Volts. Such is illustrated in FIG. 5 by the drop in Vₒᵤₜ contemporaneous with the drop in the input voltage Vᵢₙ.

Not unlike the behavior of the regulator circuit 14 with reference to FIG. 4 that does not include operation of the current sensing circuit 20, FIG. 5 further illustrates the feedback voltage V_{fb} during operation of the regulator circuit 14 when the circuit employs the current limiting. As described hereinabove with reference to FIG. 3, the operational amplifier 35 tends to maintain its inverting input (+) and its non-inverting input (−) at the same voltage. Therefore, as an example, if the voltage applied at the inverting input (+) is 1.65 Volts, then the operational amplifier 35 tends to maintain the feedback voltage V_{fb} at the same 1.65 Volts, which is the voltage illustrated in the example provided by FIG. 4. However, when the diode 34 is forward biased, because the input current attempts to exceed the 0.5 amp predetermined current threshold value, the current sensing circuit 20 increases the voltage at V_{fb}, which is still maintained by the regulating action of amplifier 35 at 1.65 volts. However, the current sensing circuit 20 limits the current drawn from the battery 18, which decreases the output voltage Vₒᵤₜ, as described hereinabove.

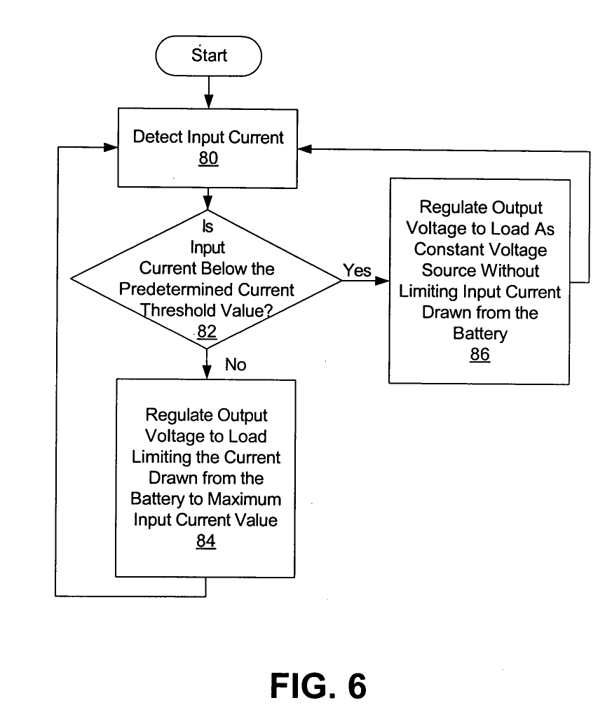

FIG. 6 is a flowchart depicting exemplary architecture and functionality of the regulator circuit 14.

The regulator circuit 14 (FIG. 1) detects an input current resulting from an input voltage Vᵢₙ (FIG. 1) supplied by a battery 18 (FIG. 1) in step 80. If the input current is below a predetermined current threshold value in step 82, then the regulator circuit 14 regulates its output voltage to a substantially constant output voltage Vₒᵤₜ using the control circuit's internal feedback voltage V_{fb} (FIG. 3) in step 86.

However, if the input current exceeds the predetermined current threshold value in step 82, then the current sensing circuit 20 provides an input control current to the control circuit 41, thereby limiting the current drawn from the battery 18 in step 84. Therefore, the current drawn from the battery 18 is limited to the predetermined current threshold value, and the output voltage Vₒᵤₜ is maintained by the feedback circuit 40 via the input control current provided by the current sensing circuit 20. As described herein, when the current sensing circuit 20 limits the current that can be drawn from the battery 18, the output voltage Vₒᵤₜ is not maintained at substantially 5 Volts. Instead, as in the example provided, while the input voltage Vᵢₙ is at the 1.8 Volts and the input current drawn from the batter is limited to the 0.5 amps, the output voltage decreases from the substantially constant 5 Volts, as is illustrated with reference to the graph in FIG. 5.

1. A battery management system for managing current supplied by a battery to a load, the system comprising:
a circuit configured to detect an input current and to drive the load at a substantially constant voltage if the detected input current is below a predetermined current threshold, the circuit further configured to limit the input current to the predetermined current threshold, thereby allowing the output voltage to decrease when the input current is being limited to the threshold by the circuit.

2. A battery management system of claim 1, wherein the circuit is implemented in a digital camera.

3. The battery management system of claim 1, wherein the circuit transmits a control signal indicative of the input current if the detected input current is above the predetermined current threshold.

4. The battery management system of claim 1, wherein the load comprises a motor.

5. The battery management system of claim 1, wherein the circuit comprises a current controlled voltage amplifier configured to receive the input current from the battery and provide an amplified output voltage based upon the input current received.

6. The battery management system of claim 5, wherein the current controlled voltage amplifier is further configured to apply a gain to the current.

7. The battery management system of claim 1, wherein the input current exhibits an input current waveform and the circuit further comprises a filter for averaging the input current waveform, thereby providing an averaged input current.

8. The battery management system of claim 7, wherein the circuit further comprises a voltage controlled voltage amplifier configured to scale the averaged input current represented by a voltage such that the scaled averaged input current is substantially equal to a reference voltage applied to the circuit when the input current is at the predetermined current threshold.

9. The battery management system of claim 8, wherein the circuit further comprises a diode, the diode configured to forward bias when the scaled averaged input current is greater than the predetermined current threshold.

10. A battery management method for managing current supplied by a battery to a load, the method comprising the steps of:
detecting a current;
driving, based on the current, the load with a constant voltage if the current is below a predetermined current threshold; and
reducing the voltage when the input current reaches the predetermined current threshold such that the current is limited to the predetermined current threshold.

11. The battery management method of claim 10, further comprising the step of transmitting a control signal indicative of the input current if the detected input current is above the predetermined current threshold.

12. The battery management method of claim 10, wherein the load comprises a motor.

13. The battery management method of claim 10, further comprising the step of applying a gain to the input current.

14. The battery management method of claim 10, wherein the input current comprises a waveform, and wherein the method further comprises the step of filtering the current waveform thereby providing an averaged current.

15. The battery management method of claim 14, further comprising the step of scaling the averaged current such that a voltage representative of the scaled averaged current is substantially equal to a reference voltage when the current supplied by the battery is at the predetermined current threshold value.

16. The battery management method of claim 10, further comprising the step of selecting between a feedback voltage and the current to regulate the voltage.

17. The battery management method of claim 16, wherein the selecting step further comprises the step of selecting the feedback voltage if the current is less than the predetermined current threshold.

18. The battery management method of claim 16, wherein the selecting step further comprises the step of selecting the current if the current is greater than the predetermined current threshold.

19. A battery management system for managing current supplied by a battery to a load, the system comprising:
means for detecting an input current;
means for driving the load at a substantially constant voltage if the detected input current is below a predetermined current threshold value; and
means for reducing the voltage when the input current reaches the predetermined current threshold, thereby limiting the input current to the predetermined current threshold if the load attempts to draw more than the predetermined current threshold.

20. A battery management system, the system comprising:
a converter circuit configured to receive an input voltage from a battery and to convert the received input voltage into a substantially constant output voltage; and
a current sensing circuit configured to detect an input current resulting from the input voltage from the battery, the current sensing circuit configured to transmit a control signal to the converter circuit if the input current reaches a current threshold, the converter circuit further configured to allow the output voltage to decrease based on the control signal.

21. The battery management system of claim 20, wherein the current sensing circuit comprises a diode, the diode configured to forward bias if the input current reaches the current threshold, thereby transmitting the control signal to the converter circuit.
